(19) United States
(12) Patent Application Publication
(10) Pub. No.: US 2016/0216410 A1
(43) Pub. Date: Jul. 28, 2016

(54) REFLECTION-PREVENTING FILM, POLARIZING PLATE, COVER GLASS, AND IMAGE DISPLAY DEVICE, AND METHOD FOR PRODUCING REFLECTION-PREVENTING FILM

(71) Applicant: FUJIFILM Corporation, Tokyo (JP)

(72) Inventors: Miho ASAHI, Kanagawa (JP); Shuntaro IBUKI, Kanagawa (JP); Takayasu YAMAZAKI, Kanagawa (JP)

(73) Assignee: FUJIFILM Corporation, Tokyo (JP)

(21) Appl. No.: 15/089,678

(22) Filed: Apr. 4, 2016

Related U.S. Application Data
(63) Continuation of application No. PCT/JP2014/075129, filed on Sep. 22, 2014.

(30) Foreign Application Priority Data
Oct. 4, 2013 (JP) 2013-209340

(51) Int. Cl. G02B 1/118; G02B 5/30; G02B 1/111

(52) U.S. Cl. CPC G02B 1/118; G02B 1/111; G02B 5/3033

(57) ABSTRACT

A reflection-preventing film having: a substrate; and a reflection-preventing layer having a concave-convex structure on a surface, in which the reflection-preventing layer includes particles for forming convex portions, and a binder resin, the particles for forming convex portions are not in contact with each other, and IVA which is a ratio of a distance A between peaks of adjacent convex portions and a distance B in a height direction from a center of the distance A to a concave portion is greater than 0.5.

### CROSS REFERENCE TO RELATED APPLICATION

This is a continuation of International Application No. PCT/JP2014/075129 filed on Sep. 22, 2014, and claims priority from Japanese Patent Application No. 2013-209340 filed on Oct. 4, 2013, the entire disclosures of which are incorporated herein by reference.

### BACKGROUND OF THE INVENTION

1. Field of the Invention

The present invention relates to a reflection-preventing film, a polarizing plate, a cover glass, and an image display device, and a method for producing a reflection-preventing film.

2. Description of the Related Art

A reflection-preventing film may he provided in an image display device such as a cathode ray tube display device (CRT), a plasma display (PDP), an electroluminescent display (ELD), a fluorescent display (VFD), a field-emission display (FED), and a liquid crystal display device (LCD), in order to prevent decrease in contrast and the reflected glare of the image, due to the reflection of the external light on the display surface. In addition, in addition to the image display device, a reflection-preventing function may he provided due to the reflection-preventing film.

As the reflection-preventing film, a reflection-preventing film having a fine uneven shape of which a cycle is a wavelength of visible light or less on the substrate surface, and a reflection-preventing film having a so-called a moth eye structure is known. According to the moth eye structure, a refractive index gradient layer of which a refractive index continuously changes from the air to a bulk material inside the substrate in a pseudo manner is made, and the reflection of light can be prevented. With respect to the reflection-preventing film having a concave-convex structure on the surface, it is known that a ratio of the distance between the convex portions and the depth of a concave portion is important for the reduction in reflectivity.

In JP2009-139796A, as the reflection-preventing film having a moth eye structure, a reflection-preventing film having a concave-convex structure which is produced by applying a coating liquid containing a transparent resin monomer and fine particles on a transparent substrate. curing the coating liquid, forming a transparent resin on which tine particles are dispersed, and thereafter etching the transparent resin is disclosed.

### SUMMARY OF THE INVENTION

However, it is desirable that reflectivity is further reduced in the reflection-preventing film disclosed in JP2009-139796A.

An object of the invention is to provide a reflection-preventing film which has low reflectivity and excellent reflection-preventing properties in the reflection-preventing film having a concave-convex structure on the surface, In addition, another object of the invention is to provide a polarizing plate, a cover glass, and an image display device which include the reflection-preventing film.

The present inventors have diligently conducted research to find that, even in a reflection-preventing film obtained by forming a concave-convex structure on a surface by using fine particles, a ratio of a distance between convex portions and a depth of a concave portion is important for reduction of reflectivity, and find a method of realizing the same.

That is, if the depth of the concave portion with respect to the distance between the convex portions is great, a refractive index gradient layer in which a refractive index gently changes from the air to the inside of the reflection-preventing layer can be formed, and thus the reflectivity can be reduced. Therefore, it is important to dispose particles so as to have a space therebetween and not to he in contact with each other. In the case where the particles are in contact with each other, only the surface side at the position at which particles are in contact with each other is recognized as an uneven portion, and thus a portion which is far from the surface of the position at which particles are in contact with each other may not be used, and the depth of the concave portion may not increase.

However, in general, the particles aggregate, the particles come into contact with each other, and thus it is difficult to cause the depth of the concave portion to be great. JP2009-139796A discloses an average distance between centers of the nearest particles of the fine particles for forming the uneven structure and an average height of the convex portions, but it is considered that fine particles are in contact with each other in the uneven structure produced in the producing method disclosed in JP2009-139796A, and it is desirable that the reflectivity is further reduced.

The present inventors have found that the objects can be achieved by the following means.

[1]

A reflection-preventing film having:

a substrate; and

a reflection-preventing layer having a concave-convex structure on a surface,

in which the reflection-preventing layer includes particles for forming convex portions, and a binder resin,

the particles for forming convex portions are not in contact with each other, and

B/A which is a ratio of a distance A between peaks of adjacent convex portions and a distance B in a height direction from a center of the distance A to a concave portion is greater than 0.5.

[2]

The reflection-preventing film according to [1], in which an average particle diameter of the particles for forming the convex portions is 50 nm to 700 nm.

[3]

The reflection-preventing film according to [1] or [2], in which the B/A is 0.6 or greater.

[4]

The reflection-preventing film according to any one of [1] to [3], in which integrated reflectivity in an entire wavelength of 380 nm to 780 nm is 3% or less.

[5]

The reflection-preventing film according to any one of [1] to [4], in which a portion which is equal to or greater than a half of the particle diameter of the particles for forming the convex portions protrudes from the binder resin.

[6]

The reflection-preventing film according to any one of [1] to [5], in which a content ratio (a. mass of the particles for forming the convex portions/a mass of the binder resin) of the binder resin to the particles for forming the convex portions is 10/90 to 95/5.

[7]

The reflection-preventing film according to any one of [1] to [6], in which the reflection-preventing layer has a particle group consisting of second particles having an average particle diameter equal to or greater than the average particle diameter of the particles for forming the convex portions, between the particle group consisting of the particles for forming the convex portions and the substrate.

[8]

The reflection-preventing film according to [7], in which an average particle diameter of the particles for forming the convex portions is 0.5 times to 1 time the average particle diameter of the second particles.

[9]

The reflection-preventing film according to any one of [1] to [6], in which surfaces of the particles for forming the convex portion are modified by a compound having an unsaturated double bond.

[10]

A polarizing plate having the reflection-preventing film according to any one of [1] to [9] as a polarizing plate protective film.

[11]

A cover glass having the reflection-preventing film according to any one of [1] to [9] as a protective film.

[12]

An image display device having the reflection-preventing film according to any one of [1] to [9] or the polarizing plate according to [10].

A method for producing a reflection-preventing film having a substrate and a reflection-preventing layer having a concave-convex structure on a surface, the method including:

applying a composition containing second particles and a monomer for forming a binder resin onto a substrate to form a first coated film; curing the first coated film with heat or light to form a cured film; applying a composition containing particles for forming a convex portion having an average particle diameter equal to or less than an average particle diameter of the second particles and a monomer for forming a binder resin onto the cured film to form a second coated film; and curing the second coated film with heat or light.

[14]

The method for producing the reflection-preventing film according to [13], in which an average particle diameter of the particles for forming the convex portion is 50 nm to 700 nm.

The method for producing the reflection-preventing film according to [13] or [14], in which a content ratio (a mass of the particles for forming the convex portions/a mass of the monomer for forming the binder resin) of the particles for forming the convex portions to the monomer for forming the binder resin is 10/90 to 95/5.

According to the invention, it is possible to provide a reflection-preventing film having a concave-convex structure on a surface, which have low reflectivity and excellent reflection-preventing properties. In addition, according to the invention, it is possible to provide a polarizing plate, a cover glass, and an image display device which include the reflection-preventing film.

### BRIEF DESCRIPTION OF THE DRAWINGS

FIG. 1 is a sectional view schematically illustrating an example of a reflection-preventing film according to the invention.

FIG. 2 is a sectional view schematically illustrating an example of the reflection-preventing film according to the invention.

FIG. 3 is a sectional view schematically illustrating an example of the reflection-preventing film according to the invention.

FIG. 4 is a view schematically illustrating a sectional SEM image of an example of the reflection-preventing film according to the invention.

### DESCRIPTION OF THE PREFERRED EMBODIMENTS

A reflection-preventing film according to the invention is a reflection-preventing film having a substrate and a reflection-preventing layer having a concave-convex structure on a surface,

in which the reflection-preventing layer includes particles for forming convex portions, and a binder resin,

the particles for forming convex portions are not in contact with each other, and

B/A which is a ratio of a distance A between peaks of adjacent convex portions and a distance B in a height direction from a center of the distance A to a concave portion is greater than 0.5.

Hereinafter, the reflection-preventing film according to the invention is described in detail.

An example of a preferred embodiment of the reflection-preventing film according to the invention is described in FIG. 1.

A reflection-preventing film 10 of FIG. 1 has a substrate 1 and a reflection-preventing layer 2 having a concave-convex structure on a surface. The reflection-preventing layer has a concave-convex structure on a surface on the opposite side of the substrate.

The reflection-preventing layer 2 includes particles 3 for forming convex portions and a binder resin 4.

The particles 3 for forming the convex portions are not in contact with each other, and

B/A which is a ratio of the distance A between peaks of adjacent convex portions and the distance B in a height direction from a center of the distance A to a concave portion is greater than 0.5.

If B/A which is a ratio of the distance A between peaks of adjacent convex portions and the distance B in a height direction from a center of the distance A to a concave portion is greater than 0.5, the reflection-preventing film according to the invention has greater depth of the concave portion with respect to the distance between the convex portions, and a refractive index gradient layer in which a refractive index gently changes from the air to the inside of the reflection-preventing layer can be formed, and thus the reflectivity can be reduced.

Hereinafter, the measuring method of B/A which is a ratio of the distance A between peaks of adjacent convex portions and the distance B in a height direction from a center of the distance A to a concave portion is described in detail.

B/A can be measured by sectional SEM observation of the reflection-preventing film. A cross section is formed by cutting a specimen of the reflection-preventing film with a microtome and observed with a SEM in appropriate magnification (about 5,000 times). For easier observation, an appropriate process such as carbon vapor deposition or etching may be performed in the specimen. When lengths are calculated at 100 points in which a distance between peaks of the adjacent convex portions is set to be A in the interface formed by the air and the specimen, a distance between a straight line connecting peaks of the adjacent convex portions and a concave portion which is a point at which the perpendicular bisector thereof reaches the particles or the binder resin in the plane which is perpendicular to the substrate surface including peaks of the adjacent convex portions is set to be B, B/A is calculated with an average value of B/A.

In the SEM picture, with respect to all the captured unevenness portions, the lengths of the distance A between peaks of the adjacent convex portions and the distance B in a height direction from a center of the distance A to a concave portion may not be correctly measured. However, in this case, the lengths are calculated by paying attention to the convex portions and the concave portions which are shown on the front side of the SEM image (see FIG. 4).

In addition, it is required that the lengths of the concave portions are measured in the same depth as the particles for forming two adjacent convex portions of which the length are measured in the SEM image. If the lengths of the concave portions are measured by setting the distance to the particles shown in the more front side to be B, it may be assumed that B is small.

In order to cause B/A to be great, it is preferable that a portion equal to or greater than the half of the particle diameter of the particles for funning the convex portions protrudes from the binder resin.

If B/A is greater than 0.5, preferably 0.6 or greater, more preferably 0.7 or greater, and still more preferably 0.8 or greater. In addition, in view of thoroughly fixing the moth eye structure and causing the abrasion resistance to be excellent, B/A is preferably 0.9 or less.

The particles for forming the convex portion is preferably spread uniformly and in a high filling ratio in order to decrease reflectivity. In addition, it is important that the filling ratio is too high. If the tilling ratio is not too high, the adjacent particles come into contact with each other such that B/A of the uneven structure becomes small.

In the point of view described above, the content of the particles for forming the convex portions is preferably adjusted to be uniformly on the entire reflection-preventing layer. The filling ratio can be measured with the area occupancy ratio of the particles positioned on the most surface side when the particles for forming the convex portions are observed on the surface with a SEM or the like. The tilling ratio is preferably 30% to 95%, more preferably 40% to 90%, and still more preferably 50% to 85%.

In the reflection-preventing film according to the invention, the particles for forming the convex portions of the uneven structure on the surface of the reflection-preventing layer are not in contact with each other.

Here, the expression “the particles for forming the convex portions are not in contact with each other” is not the exact meaning that a portion in which the particles for forming the convex portions are in contact with each other does not exist at all, but includes the case where a portion in which the particles are in contact with each other exists a little bit, due to the variations in the case of being produced in an industrial scale.

Specifically, a case where the distance A between the peaks of the adjacent convex portions that is obtained in the method described above and an average particle diameter R of the particles for forming the convex portions satisfy the relationship of A>R is considered that “the particles for forming the convex portions are not in contact with each other”. However, as described above, A in this case is an average value when distances between the peaks of the adjacent convex portions are calculated at 100 points.

Two aspects as follows are used in order to dispose the particles for forming the convex portions so as not to be in contact with each other.

(1) An aspect of spreading the particles having an average particle diameter equal to or greater than the average particle diameter of the particles consisting of the particles for forming the convex portions on the substrate and disposing the particles for forming the convex portions thereon such that the particles for forming the convex portions are not in contact with each other

(2) An aspect of using the particles of which surfaces are modified with a compound having an unsaturated double bond as the particles for forming the convex portions, such that the particles for forming the convex portions are not in contact with each other

First, the aspect (1) is described.

The aspect (1) is an aspect having the particle group (also referred to as a second particle layer) consisting of the second particles having an average particle diameter equal to or greater than the average particle diameter of the particles for forming the convex portions between the particle group (also referred to as a first particle layer) consisting of the particles for forming the convex portions and the substrate.

It is preferable that the second particles are spread on the substrate, and the particles for forming the convex portions are disposed so as to be in contact with the second particles on the second particle group. An example of this aspect is illustrated in FIG. 1.

The reflection-preventing film 10 illustrated in FIG. 1 has the particle group (second particle layer) consisting of the second particles 5 having an average particle diameter which is equal to or greater than the average particle diameter of the particles for forming the convex portions between the particle group (first particle layer) consisting of the particles 3 for forming the convex portion and the substrate 1.

The average particle diameter of the second particles is equal to or greater than the average particle diameter of the particles for forming the convex portions, and thus the particles for forming the convex portions are fitted in a recess formed by the second particle group such that the particles for forming the convex portions are disposed so as not to be in contact with each other.

In addition, in a case where the second particles are not provided on the substrate, the substrate and the particles for forming the convex portions are bound only with the binding force due to the binder resin. However, since the particles for forming the convex portions are fitted in the recess formed by the second particle group by using the second particles, the particles for forming the convex portions are more firmly fixed and abrasion resistance also increases.

The second particles may be or may not be in contact with each other.

The average particle diameter of the particles for forming the convex portions is preferably equal to or less than average particle diameter of the second particles. Accordingly, the particles for forming the convex portions are fitted in the recess formed by the second particle group and are disposed in a state in which the particles for forming the convex portions are not in contact with each other. In addition, since the particles for forming the convex portions are fitted in the recess formed by the second particle group, the particles for forming the convex portions are firmly fixed and the abrasion resistance also increases.

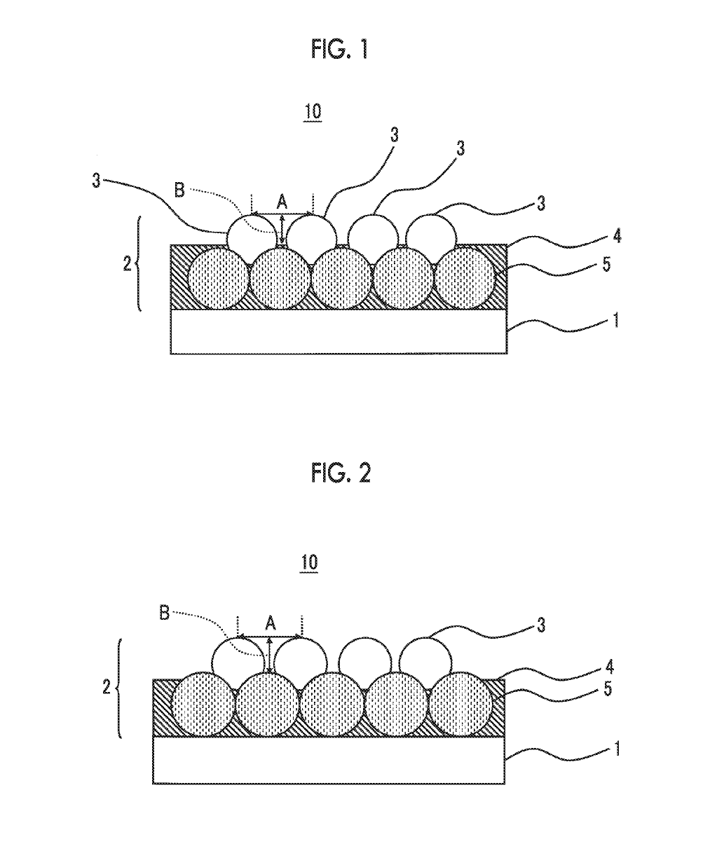

Since the particles for forming the convex portions are fitted in the recess formed by the second particle group, the particles for forming the convex portions can be fixed in constant strength even if the amount of the binder resin is reduced. An example of the aspect in which the amount of the binder resin is reduced is illustrated in FIG. 2. The reflection-preventing film 10 of FIG. 2 has a less amount of the binder resin 4 than that in the reflection-preventing film of FIG. 1, and the second particles 5 protrude from a portion of the binder resin. In the reflection-preventing film of FIG. 2, the distance B in a height direction from a center of the distance A to a concave portion becomes the distance between the center of the peaks of the adjacent convex portions and the second particles. In this aspect, since the distance B can be caused to be great, B/A can be caused to be great, and thus reflectivity can be further reduced.

The ratio of the average particle diameter of the particles for forming the convex portions and the average particle diameter of the second. particles greatly contributes to IVA which is the ratio of the distance A between the peaks of the adjacent convex portions and the distance B in a height direction from a center of the distance A to a concave portion.

It is preferable that the average particle diameter of the particles for forming the convex portions is slightly smaller than the average particle diameter of the second particles. This is because positions of the particles for forming the convex portions are determined by being fitted in the recess formed by the second particles, the particles for forming the convex portions are not in contact with the adjacent particles, and resultantly B/A can be caused to be great.

In addition, it is preferable that the average particle diameter of the particles for forming the convex portions is not too smaller than the average particle diameter of the second particles. If the particles for forming the convex portions are not too small, the distance A between the peaks of the convex portions is not caused to be great and B/A can be prevented from becoming small. Further, an effect in which positions are determined by fitting the particles for forming the convex portions in the gap of the recess formed by the second particles can be easily obtained, and whitening of the reflection-preventing layer and the decrease in strength are not likely to occur.

In a case where adjacent second particles are not in contact with each other, it is preferable that the average particle diameter of the particles for forming the convex portions is the same as the average particle diameter of the second particles, since B/A of the uneven structure of the surface can be caused to be great.

The average particle diameter of the particles for forming the convex portions is preferably 0.5 times to 1 time the average particle diameter of the second particles, more preferably 0.6 times to 0.95 times, and still more preferably 0.7 times to 0.9 times.

### (Particles for Forming Convex Portions)

Examples of the particles for forming the convex portions include metal oxide particles, resin particles, and organic inorganic hybrid particles having cores of metal oxide particles and shells of resins. However, in view of excellent film strength, metal oxide particles are preferable.

Examples of the metal oxide particles include silica particles, titania particles, zirconia particles, and antimony pentoxide particles. However, silica particles are preferable since silica particles have refractive indexes closer to those of many binders, haze is not likely to occur, and thus a moth eye structure is easily formed.

Examples of the resin particles include polyrnethyl methacrylate particles, polystyrene particles, and melamine particles.

The average particle diameter (average primary particle diameter) of the particles for forming the convex portions is preferably 50 nm to 700 nm, more preferably 100 nm to 600 nm, and still more preferably 120 nm to 500 nm.

The average primary particle diameter of the particles for forming the convex portions indicates a 50% particle diameter of the accumulation of the volume average particle diameter. In a case where the average primary particle diameter of the particles included in the reflection-preventing layer is measured, the average primary particle diameter can be measured by an electron micrograph. For example, a sliced TEM image of the reflection-preventing film is captured, respective diameters of 100 primary particles are measured to calculate the volumes thereof, and a 50% particle diameter of the accumulation can be set to be the average primary particle diameter. In a case where particles do not have sphere diameters, average values of long diameters and short diameters are considered as diameters of the primary particles.

The shape of the particles is most preferably a spherical shape, but the shape thereof may be a shape other than the spherical shape such as an undefined shape.

In addition, the silica particles may be crystalline or may be amorphous.

A surface treatment may be performed on the particles in order to improve dispersibility in the coating liquid, improve film strength, and prevent aggregation. Particularly, in view of enhancing film strength and improving abrasion resistance, the particles are preferably particles subjected to a treatment by the compound having an unsaturated double bond on the surfaces thereof. Specific examples and preferable examples of the surface treatment method are the same as those disclosed in paragraphs “0119” to “0147” of JP2007-298974A.

As the particles for forming the convex portions, commercially available particles may be used. As the specific examples, MEK-ST-L (average primary particle diameter: 50 nm, silica sol manufactured by Nissan Chemical Industries, Ltd.), MEK-ST-2040 (average primary particle diameter: 200 nm, silica sol manufactured by Nissan Chemical Industries, Ltd.), SEAHOSTAR KE-P10 (average primary particle diameter: 150 nm, amorphous silica manufactured by Nippon Shokubai Co., Ltd.), SEAHOSTAR KE-P20 (average primary particle diameter: 200 nm, amorphous silica manufactured by Nippon Shokubai Co., Ltd.), SEAHOSTAR KE-P50 (average primary particle diameter: 550 nm, amorphous silica manufactured by Nippon Shokubai Co., Ltd.), EPOSTAR S (average primary particle diameter: 200 nm, melamine formaldehyde condensate manufactured by Nippon Shokubai Co., Ltd.), EPOSTAR MA-MX100W (average primary particle diameter: 175 nm, a polymethyl methacrylate (PMMA)-based crosslinked material manufactured by Nippon Shokubai Co., Ltd.), EPOSTAR MA-MX200W (average primary particle diameter: 350 nm, a polymethyl methacrylate (PMMA)-based crosslinked material manufactured by Nippon Shokubai Co., Ltd.), STAPHYLOID (multilayer structure organic fine particles manufactured by Aica Kogyo Co., Ltd.), and GANZPEARL (polymethyl methacrylate manufactured by Aica Kogyo Ltd., polystyrene particles) can be preferably used.

With respect to the content ratio of the particles for forming the convex portions and the binder resin, it is preferable that the ratio of the particles is higher, since B/A of the unevenness of the outermost surface becomes greater. Meanwhile, if the ratio is too high, the particles are not likely to be fixed to the substrate or particles aggregate in the middle of the producing such that disorder or the deterioration of the haze is caused in some cases.

With respect to the content ratio of the particles for forming the convex portions and the binder resin, (the mass of the particles for forming the convex portions/the mass of the binder resin) is preferably 10/90 to 95/5, more preferably 20/80 to 90/10, and still more preferably 30/70 to 85/15.

In a case where the second particles are contained, the content ratio of the particles fur forming the convex portions and the second particles is not particularly limited, but (the mass of the particles for forming the convex portions/the mass of the second particles) is preferably 1/0.1 to 1/8, more preferably 1/1 to 1/5, and still more preferably 1/1.5 to 1/3. If the second particles are contained, the abrasion resistance can be enhanced. If the blending ratio is caused to be the upper limit or less, it is possible to suppress the generation of the haze.

### (Binder Resin of Reflection-Preventing Layer)

The binder resin of the reflection-preventing layer is preferably obtained by curing a polymerizable compound (monomer) for forming a binder resin.

Examples of the monomer include a compound having a polymerizable functional group (a polymerizable unsaturated double bond) such as a (meth)acryloyl group, a vinyl group, a styryl group, and an allyl group. Among these, a (meth)acryloyl group and a compound having —C(O)OCH═CH₂, are preferable, and a compound having a (meth)acryloyl group is more preferable.

Specific examples of the compound having a polymerizable functional group include (meth)acrylic acid diesters of alkylene glycol, (meth)acrylic acid diesters of polyoxyalkylene glycol, (meth)acrylic acid diesters of alcohol, (meth)acrylic acid diesters of ethylene oxide or propylene oxide adducts, epoxy (meth)acrylates, urethane (meth)acrylates, and polyester (meth)acrylates.

Among these, esters of alcohol and (meth)acrylic acid are preferable (for example, 2-hydroxyethyl methacrylate), esters of polyvalent alcohol and (meth)acrylic acid are particularly preferable. Examples thereof include pentaerythritol tetra(meth)acrylate, pentaerythritol tri(meth)acrylate, trimethylolpropane tri(meth)acrylate, EO-modified trimethylolpropane tri(meth)acrylate, PO-modified trimethylolpropane tri(meth)acrylate, EO-modified phosphoric acid tri(meth)acrylate, trimethylolethane tri(meth)acrylate, di trimethylolpropane tetra(meth)acrylate, dipentaerythritol tetra(meth)acrylate, dipentaerythritol penta(meth)acrylate, dipentaerythritol hexa(meth)acrylate, pentaerythritol hexa(meth)acrylate, 1,2,3-cyclohexane tetramethacrylate, urethane acrylate, polyester polyacrylate, and caprolactone-modified tris(acryloxyethyl) isocyanurate.

The binder resin preferably includes a resin obtained by curing a compound having a (meth)acryloyl group having a molecular weight of 150 to 1,600. The molecular weight of the compound having the (meth)acryloyl group is more preferably 170 to 1,400 and still more preferably 200 to 1,200. If the molecular weight is the lower limit or greater, it is possible to cause the strength of the reflection-preventing layer to be sufficiently great. If the molecular weight is the upper limit or less, it is easy to form a favorable permeable layer.

In addition, in a case where the compound is a polymer, the molecular weight is a mass average molecular weight in terms of polystyrene which is measured by a gel permeation chromatography.

### (Second Particles)

As the second particles, particles which are the same as the particles for forming the convex portions can be used.

The average particle diameter of the second particles is preferably 50 nm to 700 nm, more preferably 100 nm to 600 nm, and still more preferably 120 nm to 500 nm.

In this manner, the average particle diameter of the second particles is preferably greater than the average particle diameter of the particles for forming the convex portions.

### (Method for Producing Reflection-Preventing Film)

The reflection-preventing film in the aspect (1) can be produced by applying a composition containing the second particles and a monomer for forming a binder resin onto a substrate, curing the coated film with heat or light; applying a composition containing the particles for forming the convex portion and the monomer for forming the binder resin onto the coated film, and curing the coated film with heat or light.

The composition may include a solvent, a polymerization initiator, a dispersing agent of particles, a leveling agent, and an antifouling agent.

As the solvent, a solvent having polarity close to that of the fine particles is preferably selected, in view of improvement of the dispersibility. Specifically, for example, in a case where the fine particles are metal oxide fine particles, an alcohol-based dissolving agent is preferable, and examples thereof include methanol, ethanol, 2-propanol, 1-propanol, and butanol. In addition, for example, in a case where fine particles are metal resin particles or resin particles which are subjected to hydrophobization surface modification, ketone-based, ester-based, carbonate-based, alkane, or aromatic dissolving agents are preferable. Examples thereof include methyl ethyl ketone (MEK), dimethyl carbonate, methyl acetate, acetone, methylene chloride, and cyclohexanone. Plural types of these dissolving agents may be used in a mixture in a range in which dispersibility is not greatly deteriorated.

It is easy to uniformly dispose the dispersing agent of the particles by decreasing cohesive force between particles. The dispersing agent is not particularly limited, but an anionic compound such as sulfuric acid salt and phosphoric acid salt, a cationic compound such as aliphatic amine salt and quaternary ammonium salt, a nonionic compound, and a polymer compound are preferable, and, since it is free to select an adsorbing group and a stereoscopic repulsion group respectively, a polymer compound is more preferable. As the dispersing agent, commercially available products may be used. Examples thereof include DISPERBYK 160, DISPERBYK 161, DISPERBYK 162, DISPERBYK 163, DISPERBYK 164, DISPERBYK 166, DISPERBYK 167, DISPERBYK 171, DISPERBYK 180, DISPERBYK 182, DISPERBYK 2000, DISPERBYK 2001, DISPERBYK 2164, Bykumen, BYK-P104, BYK-P104S, BYK-220S, Anti-Terra203, Anti-Terra204, and Anti-Terra205 (all product names) manufactured by BYK-Chemie japan K.K.

The leveling agent decreases the surface tension of the coating liquid so as to stabilize the liquid after application and to easily cause the particles or the binder resin to be uniformly disposed. For example, compounds disclosed in JP2004-331812A and JP2004-163610A can be used.

The antifouling agent provides water repellent and oil repellent properties to the moth eye structure so as to prevent the attachment of dirt or a fingerprint. For example, compounds disclosed in JP2012-88699A can be used.

### (Polymerization Initiator)

In a case where the polymerizable compound for forming the hinder resin is a photopolymerizable compound, it is preferable to include a photopolymerization initiator.

Examples of the photopolymerization initiator include acetophenones, benzoins, benzophenones, phosphine oxides, ketals, anthraquinones, thioxanthones, an azo compound, peroxides, 2,3-dialkyldione compounds, disulfide compounds, fluoroamine compounds, aromatic sulfoniums, lophine dimers, onium salts, borate salts, active esters, active halogens, an inorganic, complex, and coumarines. Specific examples, preferable aspects, and commercially available products of the photopolymerization initiator are disclosed in paragraphs “0133” to “0151” of JP2009-098658A, and can be appropriately used in the invention in the same manner.

Various examples are disclosed in page 159 of “Recent UV curing technologies” {Technical Information Institute Co., Ltd.} (1991) and. pages 65 to 148 of “Ultraviolet ray curing system” written by Kato Kiyomi (1989, issued by United Engineering Center) and are useful for the invention.

The method for applying the composition is not particularly limited, and well-known methods can be used. Examples thereof include a dip coating method, an air knife coating method, a curtain coating method, a roller coating method, a wire bar coating method, a gravure coating method, and a die coating method.

In order to easily cause the composition to be uniformly applied, the solid content concentration of the composition is preferably 10 mass % to 80 mass % and more preferably 20 mass % to 60 mass %.

When the composition containing the second particles and the monomer for forming the binder resin are applied, and the coated film is cured with heat or light, it is preferable that the composition is not completely cured, but the composition is caused to be in a semi-cured state by adjusting temperature or irradiation energy, in view of improving adhesiveness to the particles for forming the convex portions provided thereon.

In addition, as another producing method different from the above, there is a method of applying a composition containing the particles for forming the convex, portions, the second particles, and the binder: resin onto the substrate, and causing the particles for forming the convex portions to be unevenly distributed on the air interface side.

Subsequently, the aspect (2) of using particles of which the surfaces are modified, with the compound having the unsaturated double bond as the particles for fanning the convex portions is described.

According to this aspect, it is possible to form the reflection-preventing layer in which the particles for forming the convex portions are not in contact with each other, and B/A which is the ratio of the distance A between the peaks of the adjacent convex portions and the distance B in a height direction from a center of the distance A to a concave portion is greater than 0.5, by using the particles of which the surfaces are modified with the compound having the unsaturated double bond, as the particles for forming the convex portions, not using the second particles between the substrate and the particles for forming the convex portions as in the aspect (1), but only using the particles for forming the convex portions.

Even with fine particles which are not modified with the compound having an unsaturated double bond, a moth eye structure can be formed in some cases. However, these particles easily aggregate with each other, and there is a tendency in that adjacent particles for forming convex portions easily come into contact with each other.

If particles of which surfaces are modified with a compound having an unsaturated double bond are used, aggregation of the particles can be easily prevented. The reason thereof is not clear, but it is assumed that an unsaturated double bond is highly compatible with the binder resin and stably exists even if particles are not gathered with each other.

The compound having the unsaturated double bond is the same as those disclosed in “0119” to “0147” of JP2007-298974A, but a silane coupling agent is preferable, and a silane coupling agent having a (meth)acryloyl group is more preferable. As the compound having the unsaturated double bond, specifically, vinyltrimethoxysilane, 3 -methacryloxypropyltrimethoxysilane, 3-methacryloxypropyltriethoxysilane, 3-acryloxypropyltrimethoxysilane, and the like can be preferably used.

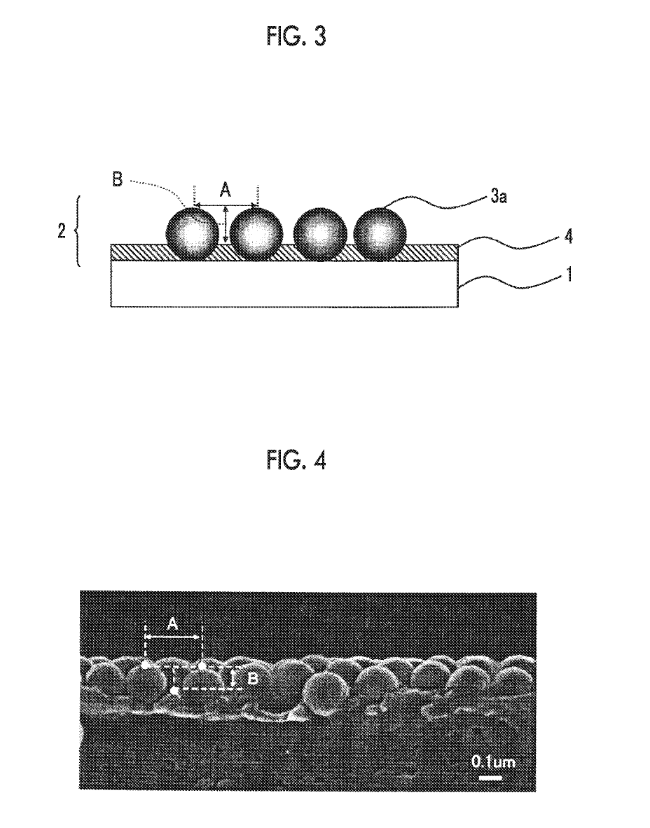

An example of the reflection-preventing film of the aspect (2) is illustrated in FIG. 3.

The reflection-preventing film 10 of FIG. 3 has the particles for forming the convex portions which are particles 3a of which surfaces are modified with the compound having an unsaturated double bond.

The reflection-preventing film of the aspect (2) can be produced by applying a composition containing the monomer for forming the binder resin and the particles of which surfaces are modified with the compound having the unsaturated double bond on the substrate and curing the coated film with heat or light.

The composition may include a solvent, a polymerization initiator, a dispersing agent of particles, a leveling agent, and an antifouling agent.

A preferable range of the solid content concentration of the composition is the same as in the case of the aspect (1).

### [Reflection-Preventing Layer]

The surface of the opposite side of the substrate of the reflection-preventing layer has a concave-convex structure (a moth eye structure) formed by the particles for forming the convex portions.

Here, the moth eye structure is a processed surface of a substance (material) for preventing the reflection of light and refers to a structure having a cyclic fine structure pattern. Particularly, in the case of the purpose of preventing the reflection of visible light, the moth eye structure refers to a structure having a fine structure pattern having a cycle less than 780 nm. If the cycle of the fine structure pattern is less than 380 nm, a color tone of reflected light disappears, and thus the cycle of less than 380 nm is preferable. In addition, if the cycle is 100 nm or greater, the light having the wavelength of 380 nm is preferable, since the fine structure pattern is recognized, and reflection-preventing properties are excellent. Whether a moth eye structure exists or not can be checked by observing a surface shape due to a scanning electron microscope (SEM) and an atomic force microscope (AFM) and examining whether the fine structure pattern is formed.

### [Substrate]

The substrate in the reflection-preventing film according to the invention is riot particularly limited, as long as the substrate is a transparent substrate which is generally used as a substrate of a reflection-preventing film. However, a plastic substrate or a glass substrate is preferable.

As the plastic substrate, various substrates can be used. Examples thereof include a substrate containing a cellulose-based, resin; a polyester resin such as cellulose acylate (triacetate cellulose, diacetyl cellulose, and acetate butyrate cellulose); a (meth)acryl-based resin such as polyethylene terephthalate, a polyurethane-based resin, polycarbonate, polystyrene, and an olefin-based resin. In view of easily producing a permeable layer, a substrate containing cellulose acylate, polyethylene terephthalate, or a (meth)acryl-based resin is preferable, and a substrate containing cellulose acylate is more preferable. As cellulose acylate, substrates disclosed in JP2012-093723A are preferably used.

The thickness of the plastic substrate is generally about 10 μm to 1,000 μm. In view of obtaining favorable handling properties, high transparency, and sufficient strength, the thickness is preferably 20 μm to 200 μm and more preferably 25 μm to 100 μm. As the transparency of the plastic substrate, a substrate having transmittance of 90% or greater is preferable.

The plastic substrate may comprise another resin layer on the surface. For example, the plastic substrate may comprise a hard coat layer for providing hard coat properties, an easily adhesive layer for providing adhesiveness to other layers, or a layer for providing antistatic properties, or the plastic substrate may comprise plural layers thereof.

### [Polarizing Plate]

The polarizing plate according to the invention is a polarizer and a polarizing plate having at least one sheet of the protective films that protects the polarizer, and at least one sheet of the protective films is the reflection-preventing film according to the invention.

The polarizer includes an iodine-based polarizing film, a dye-based polarizing film using a dichroic dye or a polyene-based polarizing film. The iodine-based polarizing film and the dye-based polarizing film can be produced generally by using a polyvinylalcohol-based film.

### [Cover Glass]

The cover glass according to the invention has the reflection-preventing film of the invention as a protective film. The substrate of the reflection-preventing film may be a glass substrate or may be a substrate obtained by bonding a reflection-preventing film having a plastic film substrate on a glass support.

### [Image Display Device]

The image display device according to the invention may have the reflection-preventing film or the polarizing plate according to the invention.

The reflection-preventing film and the polarizing plate according to the invention can be appropriately used in a image display device such as a liquid crystal display device (LCD), a plasma display panel (PDP), an electroluminescent display (HD), or a cathode ray tube display device (CRT). Particularly, a liquid crystal display device is preferable.

In general, a liquid crystal display device has a liquid crystal cell and two sheets of polarizing plates disposed. on both sides of the liquid crystal cell, and the liquid crystal cell carries liquid crystal in a portion between two sheets of electrode substrates. Further, one optical anisotropic layer is disposed between the liquid crystal cell and one polarizing plate, or two optical anisotropic layers are disposed between the liquid crystal cell and both polarizing plates. The liquid crystal cell is preferably in a TN mode, a VA mode, an OCB mode, an IPS mode, or an ECB mode.

### EXAMPLES

Hereinafter, the invention is described in detail with reference to examples. Materials, reagents, amounts of substances, and ratios thereof operations, and the like presented in examples below can be appropriately changed without departing from the gist of (lie invention. Therefore, the scope of the invention is not limited to the following specific examples.

### (Preparation of Particle Dispersion Liquid Z-1)

480 parts by mass of methanol was added to 100 parts by mass of KE-P20 (SEAHOSTAR manufactured by Nippon Shokubai Co., Ltd., amorphous silica particles, average particle diameter: 0.2 μm), and the resultant was stirred in a mixing tank, to obtain 20 mass % of silica dispersion liquid. Further, 20 parts by mass of acryloyloxypropyltrimethoxysilane, and 1.5 parts by mass of diisopropoxyaluminumethyl acetate were added thereto and mixed, and thereafter 9 parts by mass of ion exchange water was added. After reaction was performed for 8 hours at 60° C., cooling was performed to the room temperature, and 1.8 parts by mass of acetylacetone was added. While MEK was added such that the total liquid amount was substantially constant, the solvent was substituted by distillation under reduced pressure. Finally, the solid content concentration was adjusted to be 20 mass %, such that a dispersion liquid Z-1 was prepared.

### (Preparation of Coating Liquid for Forming Particle Layer)

Respective components were input to the mixing tank such that the compositions of Table 1 below were satisfied, stirring was performed for 60 minutes, ultrasonic dispersion was performed for 30 minutes, and filtration was performed with a filter made of polypropylene having a hole diameter of 5 μm, so as to obtain a coating liquid for forming a particle layer.

in Table 1 below, numerical values of the respective components refer to addition amounts (parts by mass).

TABLE 1

| Coating liquid for | | | | | | | |
|---|---|---|---|---|---|---|---|
| forming particle layer | | A-1 | A-2 | A-3 | A-4 | B-1 | B-2 |
| Compound for | PET 30 | 412 | 246 | 288 | 246 | 57 | 57 |
| forming binder resin | HEMA | 103 | 62 | 72 | 62 | | |
| Particles | Silica particles having average | 72 | | | | | |
| | particle diameter of 0.3 μm | | | | | | |
| | Silica particles having average | | 84 | 32 | | 89 | |
| | particle diameter of 0.2 μm | | | | | | |
| | Silica particles having average | | | | | | 89 |
| | particle diameter of 0.18 μm | | | | | | |
| | Dispersion liquid Z-1 | | | | 420 | | |
| Others | IRGACURE 184 | 12 | 8 | 8 | 8 | 4 | 4 |
| | Fluorine-containing polymer p | 0.6 | 0.4 | 0.4 | 0.4 | 0.2 | 0.2 |
| | Ethanol | 400 | 600 | 600 | 264 | 850 | 850 |

| | | | | | | |
|---|---|---|---|---|---|---|
| Liquid concentration (mass %) | 60% | 40% | 40% | 40% | 15% | 15% |
| Blending ratio of particles/binder resin (mass ratio) | 12/88 | 21/79 | 8/92 | 21/79 | 61/39 | 61/39 |

Respectively used compounds are presented below.

PET 30: Mixture of pentaerythritol tetraacrylate and pentaerythritol triacrylate (manufactured by Nippon Kayaku Co., Ltd.)

HEMA: 2-hydroxyethyl methacrylate (manufactured by Mitsubishi Rayon Co., Ltd.)

IRGACURE 184: photopolymerization initiator (manufactured by BASF Japan K.K.)

Fluorine-containing polymer p: Fluorine-based polymer P-10 disclosed in JP2004-163610A

Silica particles having an average particle diameter of 0.3 μm: KE-P30 (SEAHOSTAR. manufactured by Nippon Shokubai Co., Ltd., amorphous silica particles)

Silica particles having an average particle diameter of 0.2 μm: KE-P20 (SEAHOSTAR manufactured by Nippon Shokubai Co., Ltd., amorphous silica particles)

Silica particles having an average particle diameter of 0.18 μm were prepared as follows.

### (Preparation of Silica Particles Having an Average Particle Diameter of 0.18 μm)

With reference to Example 3 and Example 23 disclosed in JP2012-214340A, silica particles were prepared. as follows. Methyl ethyl ketone: 46 ml, water: 2 ml, triethylamine: 0.5 ml, and tetramethoxy silane: 1.8 ml were put into a 100 ml flask, stirring was performed for 3 minutes, resting was performed for 1 hour, and thereafter the liquid was evaporated by using an evaporator, so as to obtain a white solid matter. It was checked that particles having an average particle diameter of 0.18 μm was able to be obtained, from the observation image measured. with a SEM.

### (Producing of Reflection-Preventing Film)

### <Aspect Having Only First Particle Layer Consisting of Particles for Forming Convex Portions>

A coating liquid A-1 for forming a particle layer was applied to a cellulose triacetate film (TDH60UF, manufactured by Fujifilm Corporation) having thickness of 60 μm by using a gravure coater in a Wet application amount of about 3.5 ml/m², drying was performed at 120° C. for 5 minutes, and thereafter curing was performed by irradiation with ultraviolet light in an irradiation amount of 600 mJ/cm² using an air-cooling metal halide lamp, while nitrogen purge was performed to have an atmosphere in which an oxygen concentration is 0.1 volume % or less. At this point, the Wet application amount was finely adjusted, a particle occupancy ratio was measured, and a film having the highest ratio was employed as a reflection-preventing film A-1. In the same method except that coating liquids A-2 to A-4 for forming particle layers were used instead of the coating liquid A-1 for forming a particle layer, and the Wet application amount was changed to about 2.8 ml/m², reflection-preventing films A-2 to A-4 were produced.

### <Aspect Having Second Particle Layer Between Substrate and First Particle Layer Consisting of Particles for Forming Convex Portions>

An underlayer A-2-2 which was the second particle layer was produced in the same method as the reflection-preventing film A-2 except for changing an ultraviolet light irradiation amount of 60 mJ/cm². Moreover, coating liquid B-1 or B-2 for forming a particle layer was applied using a gravure coater in a Wet application amount of about 2.8 ml/m², drying was performed at 120° C. for 1 minute, and thereafter curing was performed by irradiation with ultraviolet light in an irradiation amount of 600 mJ/cm² using an air-cooling metal halide lamp, while nitrogen purge was performed to have an atmosphere in which an oxygen concentration is 0.1 volume % or less. At this point, the Wet application amount was finely adjusted, a particle occupancy ratio was measured, and films having the highest ratio were employed as reflection-preventing films 13-1 and B-2.

### (Evaluation of Reflection-Preventing Films)

Various characteristics of the reflection-preventing film were evaluated by the following methods. The results are presented in Table 2.

### (Particle Occupancy Ratio)

The particle occupancy ratio was measured as an area occupancy ratio of the convex portions on the specimen surface. After carbon vapor deposition on the surface of the film specimen, 10 viewing fields were observed and captured by using a scanning electron microscope (SEM) at 5,000 times. By using image analysis software WinROOF (manufactured by Mitani Corporation), the area occupancy ratios of all obtained images were measured respectively, and the average value thereof was set to be a particle occupancy ratio.

### (B/A)

A cross section is formed by cutting a film specimen with a microtome, carbon vapor deposition was performed on the cross section, and thereafter an etching treatment was performed for 10 minutes. 20 viewing fields were observed and captured by using a scanning electron microscope (SEM) at 5,000 times. In the obtained image, with respect to the interface formed by the air and the specimen, the distances A between the peaks of the adjacent convex portions and the distances B between the centers of peaks of the adjacent convex portions and the concave portions were measured at 100 points, and calculated as an average value of B/A.

### (Integrated Reflectivity)

After a back surface of the film (surface on the opposite side of a side having the reflection-preventing layer of the cellulose triacetate film) was roughened with sandpaper and was treated with black ink, an adapter ARV-474 was mounted to a spectrophotometer V-550 (manufactured by JASCO Corporation) in a state in which reflection on the back surface was removed, integrated reflectivity was measured in the wavelength area of 380 nm to 780 nm at an incident angle of 5°, and an average reflectivity was calculated, so as to evaluate reflection-preventing properties.

### (Haze)

Uniformity of the surface was evaluated by the haze value. If the particles aggregate with each other and are non-uniform, the haze increases. Conforming to JIS-K7136, an obtained total haze value (%) of the film was measured. In the device, a haze meter NDH4000 manufactured by Nippon Denshoku Industries Co., Ltd. was used.

Haze value was 2% or less . . . There was no cloudiness feeling and uniformity of the surface was excellent.

Haze value was 5% or less . . . There was slightly cloudiness feeling but there was no problem in appearance.

Haze value was greater than 5% . . . Cloudiness feeling was great, but appearance was deteriorated.

### (Reflection)

An adhesive agent was attached to the back surface (surface on the opposite side of the side having the reflection-preventing layer of the cellulose triacetate film) of the film cut into the size of 10 cm×30 cm, and the film was attached to a liquid crystal display. The display was installed to a white wall in the interior having illuminance of about 1,000 Lx, and a black display is performed, and the black feeling was observed.

A: Reflection was not seen, and black feeling was very excellent.

B: Reflection was slightly seen, but black feeling was very excellent, and thus there was no problem.

C: Reflection was seen, but black feeling was excellent, and thus there was no problem.

D: Reflection was strong, and black feeling was slightly deteriorated.

E: Reflection was strong, and black feeling was considerably deteriorated.

### (Evaluation of Steel Wool Abrasion Resistance)

A rubbing test was performed on the surface of the reflection-preventing layer of the reflection-preventing film, in the following conditions by using a rubbing tester, so as to obtain the index of the abrasion resistance.

Evaluation environmental condition: 25° C., 60% RH

Rubbing material: steel wool (manufactured by Nihon Steel Wool Co., Ltd., Grade No.

A rubbing tip portion (1 cm×1 cm) of the tester coming into contact with the specimen was wound, and was fixed with a band

Moving distance (one way): 13 cm,

Rubbing speed: 13 cm/seconds,

Load: 400 g/cm²

Tip portion contact area: 1 cm×1 cm,

The number of times of rubbing: 10 round trips

Oil black ink was applied to the back surface (surface on the opposite side of the side having. the reflection-preventing layer of the cellulose triacetate film) of the specimen on which rubbing was completed, visual observation was performed with reflection light, and abrasion on the rubbed portion was evaluated.

A: Even if the rubbed portion was very carefully seen, abrasion was not seen at all.

B: If the rubbed portion was very carefully seen, slight abrasion was seen, but there are a little abrasion, and thus there was no problem.

C: If the rubbed portion was carefully seen, slight abrasion was seen, but there was no problem.

D: Intermediate abrasion was seen, and thus the abrasion was noticeable.

E: There was abrasion seen at first glance, and thus the abrasion was very noticeable.

TABLE 2

| Reflection-preventing film | A-1 | A-2 | A-3 | A-4 | B-1 | B-2 |
|---|---|---|---|---|---|---|
| Particle occupancy ratio | 78% | 78% | 78% | 78% | 55% | 45% |
| B/A | 0.55 | 0.6 | 0.2 | 0.75 | 0.6 | 0.8 |
| Reflectivity | 1.0% | 0.7% | 2.5% | 0.4% | 0.7% | 0.5% |
| Haze value (%) | 1.2 | 0.5 | 12.0 | 0.3 | 1.0 | 0.7 |
| Reflection | C | B | E | A | B | A |
| Abrasion resistance | C | C | A | B | A | A |
| | Present | Present | Comparative | Present | Present | Present |
| | Invention | Invention | Example | Invention | Invention | Invention |

As understood from Table 2, in the specimen according to the invention, a favorable image in which reflectivity and haze were low, and the reflection was prevented was able to be seen. Further, in the specimens B-1 and B-2 obtained by stacking two layers, it was found that abrasion resistance was enhanced with respect to the specimen A-2 which is the specimen before the second layer was formed.

### INDUSTRIAL APPLICABILITY

According to the invention, it is possible to provide the reflection-preventing film having the uneven structure on the surface, in which reflectivity is low and reflection-preventing properties are excellent. In addition, according to the invention, it is possible to provide a polarizing plate, a cover glass, and an image display device, which include the reflection-preventing film.

The invention is described above in detail with reference to specific aspects, but it is obvious to a person skilled in the art that various changes or modifications can be performed without departing from the gist and the range of the invention.

The present application is based on Japanese patent application (JP2013-209340) filed on Oct. 4, 2013, and the contents thereof are incorporated herein as references.

### EXPLANATION OF REFERENCES

1: substrate
2: reflection-preventing layer
3: the particles for forming the convex portions
3a: particles of which surfaces are modified with a compound having an unsaturated double bond
4: binder resin
5: second particles
10: reflection-preventing film
A: distance between peaks of adjacent convex portions
B: distance in a height direction from a center of the distance A to a concave portion

What is claimed is:

1. A reflection-preventing film comprising:
a substrate; and
a reflection-preventing layer having a concave-convex structure on a surface,
wherein the reflection-preventing layer includes particles for forming convex portions, and a binder resin.
wherein the particles for forming convex portions are not in contact with each other, and
wherein B/A which is a ratio of a distance A between peaks of adjacent convex portions and a distance B in a height direction from a center of the distance A to a concave portion is greater than 0.5.

2. The reflection-preventing film according to claim 1,
wherein an average particle diameter of the particles for forming the convex portions is 50 nm to 700 nm.

3. The reflection-preventing film according to claim 1,
wherein the B/A is 0.6 or greater.

4. The reflection-preventing film according to claim 1,
wherein integrated reflectivity in an entire wavelength of 380 nm to 780 nm is 3% or less.

5. The reflection-preventing film according to claim 1,
wherein a portion Which is equal to or greater than a half of the particle diameter of the particles for forming the convex portions protrudes from the hinder resin.

6. The reflection-preventing film according to claim 1,
wherein a content ratio of the binder resin to the particles for forming the convex portions, the content ratio represented as a mass of the particles for forming the convex portions/a mass of the binder resin, is 10/90 to 95/5.

7. The reflection-preventing film according to claim 1,
wherein the reflection-preventing layer has a particle group consisting of second particles having an average particle diameter equal to or greater than the average particle diameter of the particles for forming the convex portions, between the particle group consisting of the particles for forming the convex portions and the substrate.

8. The reflection-preventing film according to claim 7,
wherein an average particle diameter of the particles for forming the convex portions is 0.5 times to 1 time the average particle diameter of the second particles.

9. The reflection-preventing film according to claim 1,
wherein surfaces of the particles for forming the convex portion are modified by a compound having an unsaturated double bond.

10. A polarizing plate comprising the reflection-preventing film according to claim 1 as a polarizing plate protective film.

11. A cover glass comprising the reflection-preventing film according to claim 1 as a protective film.

12. An image display device comprising the reflection-preventing film according to claim 1.

13. A method for producing a reflection-preventing film having a substrate and a reflection-preventing layer having a concave-convex structure on a surface, the method comprising:
applying a composition containing second particles and a monomer for forming a binder resin onto a substrate to form a first coated film;
curing the first coated film with heat or light to form a cured film;
applying a composition containing particles for forming a convex portion having an average particle diameter equal to or less than an average particle, diameter of the second particles and a monomer for forming a binder resin onto the cured film to form a second coated film; and
curing the second coated film with heat or light.

14. The method for producing the reflection-preventing film according to 13,
wherein an average particle diameter of the particles for forming the convex portion is 50 nm to 700 nm.

15. The method for producing the reflection-preventing film according to claim 13,
wherein a content ratio of the particles for forming the convex portions to the monomer for forming the binder resin, the content ratio represented as a mass of the particles for forming the convex portions/a mass of the binder resin, is 10/90 to 95/5.
